(19) United States
(12) Patent Application Publication
(10) Pub. No.: US 2013/0107027 A1
(43) Pub. Date: May 2, 2013

(54) Control and monitoring device for vehicle

(71) Applicant: Deutsches Zentrum fuer Luft- und Raumfahrt e.V., Koeln (DE)

(72) Inventor: Mario Muellhaeuser, Braunschweig (DE)

(73) Assignee: DEUTSCHES ZENTRUM FUER LUFT- UND RAUMFAHRT E.V., Koeln (DE)

(21) Appl. No.: 13/658,073

(22) Filed: Oct. 23, 2012

(30) Foreign Application Priority Data
Oct. 27, 2011 (DE) 10 2011 054 848.3

(51) Int. Cl. H04N 7/18

(52) U.S. Cl. CPC H04N 7/18
USPC 348/77

(57) ABSTRACT

The present invention relates to a control device (1) for controlling a vehicle movement of a vehicle, having
a control command input device for inputting manual control command inputs for controlling the vehicle movement of the vehicle, and
a control signal unit (7), which is configured to generate control signals for controlling the vehicle movement of the vehicle as a function of the manual control command inputs,
   wherein the control command input device has
a camera system (2) for capturing image information relating to at least part of an operator control space of the vehicle,
an image processing unit (5), which is configured to detect body movements and/or body postures of at least one vehicle driver (4) from the captured image information, and
an evaluation unit (6) which is configured to determine the manual control command inputs as a function of the detected body movements and/or body postures.

The invention relates, on the one hand, to a control device for controlling a vehicle movement of a vehicle, having a control command input device for inputting manual control command inputs for controlling the vehicle movement of the vehicle, and a control signal unit, which is configured to generate control signals for controlling the vehicle movement of the vehicle as a function of the manual control command inputs. The invention also relates to a monitoring device for monitoring a touch-dependent control element for controlling a vehicle movement of a vehicle, and to a detection device for detecting a touch state of at least one touch-dependent control element for the controlling of a vehicle movement of a vehicle by a vehicle driver.

The control of the vehicle movement of a vehicle is generally carried out by a control device arranged in an operator control space of the vehicle and which is correspondingly operated by a vehicle driver in order to control the vehicle. In what are referred to as manned vehicles, the operator control space can be arranged in or on the vehicle here, and in the case of unmanned vehicles, said operator control space can be arranged outside the vehicle, where in the control commands are then transmitted to the vehicle via a radio link.

The control device is used by the vehicle driver to input corresponding control commands for controlling the vehicle movement, which control commands are then used by the vehicle to actuate the actuator elements which are provided for the vehicle movement. The control commands are input by the vehicle driver by activation of one or more control elements, such as, for example, by turning a steering wheel, by activating pedals, by activating a joystick in aircraft or by moving a control stick or side stick in aircraft.

In what is referred to as “steer-by-wire” the control commands which are input are not applied directly mechanically to the actuator elements, such as is the case, for example, in a steering wheel of a road vehicle, but instead the movement is sensed using sensors and converted into electrical control signals which are then used to actuate the actuator elements such as actuators. Although this has the advantage that the mechanical complexity of such control devices decreases, further redundant control possibilities must necessarily be provided for this in order to be able to compensate for a failure in the input device.

However, in any case, the control elements which are provided for inputting control commands have to be touched by the vehicle driver in order to be able to correspondingly input the control commands by applying a corresponding force to the control element and therefore bringing about a movement of the control element. The vehicle driver is therefore forced to establish and also maintain permanent haptic contact with the control elements.

Nowadays modern vehicles generally have a large number of assistance systems for assisting the vehicle driver in his vehicle control function. However, these assistance systems also have to be set by inputting corresponding instructions, which is usually done in a touch-dependent fashion nowadays. For this purpose, the vehicle driver has to suspend the contact with the control element in order briefly to correspondingly set the assistance system. However, this requires that, in addition to the shifted focusing of attention onto the assistance system, the control function can briefly no longer be performed 100% by the vehicle driver. If unexpected events which require the vehicle driver's full attention occur in this phase, it is possible that there is no longer sufficient time for the driver to regain complete control of the vehicle by touching the control elements. This results in serious accidents.

In order to solve this problem, for example, acoustic input systems have been developed with which the vehicle driver can make certain settings by means of voice signals. By using a microphone these voice signals are sensed, evaluated and, provided that a correct voice command has been recognized, used to set the desired system. However, such voice recognition has the disadvantage that in the event of an unclear pronunciation, loud operating surroundings such as, for example, in a cockpit or when several people are talking, a 100% safe and reliable recognition of the voice commands is not possible owing to the system, with the result that such systems appear rather unsuitable for a large number of fields of application.

DE 103 49 568 A1 has disclosed, for example, a hand sign switching device in which a camera can be used to recognize and detect a hand sign made by the vehicle driver within an image capturing zone, and a corresponding object can be selected and corresponding information input as a function of the hand sign which is shown. It is also disadvantageous here that in order to make the hand sign the vehicle driver has to lose contact with the control element.

A further problem exists in vehicles which can carry out their driving function completely automatically. Such vehicles can use sensors and a corresponding evaluation to carry out their driving function completely automatically to such an extent that it is generally no longer necessary for the vehicle driver to intervene. An example of this is what is referred to as the autopilot of an aircraft. However, if an unexpected event occurs with the result that the automation has to be aborted and the driving function completely transferred to the vehicle driver, a certain time passes until the vehicle driver has established contact with the necessary actuator parts or control elements of the vehicle and can therefore assume the driving function. In events critical in terms of timing this can quickly lead to serious accidents.

A problem which has previously also not been resolved is the redundancy of what are referred to as “steer-by-wire” control elements. If the sensors for sensing the movement of the control element fail, for example not only must this be detected in good time but a corresponding alternative for the control of the vehicle must also be offered to the vehicle driver so that the driving function can continue to be performed by the vehicle driver. However, since in the case of a “steer-by-wire” control there is no mechanical connection to the individual actuator parts, the electronic signal paths have to be configured at least redundantly. If a serious fault occurs at the control elements, the redundantly configured control paths may also be affected by this in their entirety with the result that it is no longer possible to control the vehicle.

An object of the present invention is therefore initially to provide an improved control device with which a vehicle can be controlled intuitively. Furthermore, it is also an object of the invention to specify a control device which can be used as a redundant system in the event of the failure of the primary control elements. Furthermore, an object of the invention is also to specify a monitoring device with which the vehicle driver can detect the failure of the primary control elements and the touch state of the control elements.

The object is achieved according to the invention with the control device of the type mentioned at the beginning in that the control command input device has
a camera system for capturing image information relating to at least part of an operator control space of the vehicle,
an image processing unit, which is configured to detect body movements and/or body postures of at least one vehicle driver from the captured image information, and
an evaluation unit which is configured to determine the manual control command inputs as a function of the detected body movements and/or body postures.

According to the invention there is therefore provision that the control device for controlling a vehicle movement of a vehicle has a control command input device with which control command inputs can be input by means of body movements and/or body postures in order to control the vehicle movement of the vehicle, and which has a control signal unit which, as a function of the control command inputs which are input, generates corresponding control signals for controlling the vehicle movement of the vehicle. These control signals can then be used, for example, to actuate the actuator elements of the vehicle which are provided for controlling the vehicle movement.

For the inputting of the manual control command inputs by means of body movement and/or body postures, the control command input device has a camera system which captures image information relating to at least one part of an operator control space of the vehicle. The operator control space may be, for example, the cockpit of an aircraft or the control location of a vehicle. By using an image processing unit, this image information, which has been captured by the camera system, is analyzed and corresponding body movements and/or body postures of the vehicle driver are detected from the captured image information. By using an evaluation unit, the control command inputs are determined from these detected body movements and/or body postures, with the result that the control signal unit can generate the control signals, on the basis of these determined control command inputs, in order to control the vehicle movement.

A body movement of the vehicle driver according to the present invention may be, for example, a gesture, facial expression or a movement pattern which is carried out by the vehicle driver. A body movement can also be a displayed hand sign or other displayable sign patterns such as, for example, from sign language. Control commands can also be derived from the body posture or the position of the body of the vehicle driver, with the result that, for example, forward inclination of the body can lead to acceleration.

It therefore becomes possible for the entire driving function to be carried out by the vehicle driver using movement patterns or hand signs without the vehicle driver having to touch or activate a corresponding control element. The input of the control commands is therefore more intuitive and more easily understandable. Furthermore, the transition from an automated driving function to a manual driving function is made significantly easier, since the vehicle driver does not have to search for contact with the control elements.

A further advantage of the contactless control of vehicles is that movement-restricted people can still control a vehicle since the control of the vehicle can now be tailored to their possible types of movement. Furthermore, applications arise in the military field, for example if the vehicle driver is injured by gunfire and could no longer carry out his control function using the touch-dependent control elements. Therefore, through a corresponding body posture or by displaying hand signs the control of the vehicle can be maintained further.

The camera system is advantageously a 3D camera system with optical depth detection. As a result it becomes possible not only to detect hand signs or displayed symbols or patterns but also movements of the hand or other body parts in space. It is therefore possible to sense complex movement patterns of the vehicle driver, which can then be used as control commands for the input.

In one particularly advantageous embodiment, the image processing unit is configured in such a way that it detects control element body movements of the vehicle driver and/or control element movements during activation of at least one touch-dependent control element from the captured image information. The image processing unit can therefore, for example, detect a control element body movement and/or control element movement during activation of a steering wheel or control stick as a control element from the captured image information, i.e. during the activation of the control element, the image processing unit detects the movements carried out by the vehicle driver to activate the control element (control element body movements) and/or the image processing unit detects the movement of the control element (control element movement) during the activation by the vehicle driver per se.

The evaluation unit is then embodied in such a way that on the basis of the detected control element body movements and/or control element movements the manual control command inputs, which are to be input by the vehicle driver with the activation of the control element in order to control the vehicle movement, are determined. These manual control command inputs which are sensed and determined in this way can then be fed to the control signal unit in order to generate on the basis thereof the control signals for controlling the vehicle movement.

It therefore becomes possible, for example, to maintain the controllability by means of the control elements provided for controlling the vehicle, by activating said control elements when they have failed, for example, owing to a defect. The control device of the present invention then functions as a backup controller.

This is advantageous in particular if additional redundancy in the case of a defect has to be established for a “drive-by-wire” controller. This is because the body movements and/or control element movements which are carried out for the purpose of control command input in order to activate the control element can be detected directly by the image processing unit and converted using the evaluation unit into the desired control command inputs, with the result that in spite of a failure of the control elements it continues to be possible to control the vehicle.

It is, however, also conceivable that the control elements basically do not contain an independent control function but rather are used only for the purpose of simple operator control of the vehicle. The sensing of the control command inputs by means of the control elements which are switched to a blind setting is then carried out using the available control device according to the invention by sensing the corresponding movements.

In one advantageous development of the exemplary embodiment above, the control device has a control element input interface via which control element control command inputs can be received. Such control element control command inputs are control command inputs which have been input by the vehicle driver by activating the control element for the purpose of controlling the vehicle movement, for example, by rotating a steering wheel or pivoting a control stick. However, by using the image processing unit the body movements and/or control element movements are at the same time sensed during the input of the control element control command inputs, and the desired control command inputs derived.

The evaluation unit is now configured in such a way that it detects a malfunction of the control element on the basis of a comparison between the control element control command inputs received via the control element input interface and the control command inputs which are sensed via the image processing unit, wherein the control signals are generated by the control signal unit as a function of the detection of the malfunction.

As a result it becomes possible that a malfunction of the control element can be detected in the case of a deviation between the detected body movements and/or control element movements and the control command inputs which can be derived therefrom and the control element control command inputs which are sensed by the control element. When a malfunction is detected, the control device according to the invention which is present can then be used as a backup controller and used to input the control command inputs, specifically instead of the sensor system of the control element.

In a further advantageous refinement, the evaluation unit is configured in such a way that it detects a critical state of the vehicle driver on the basis of the detected body movements and/or body postures of the vehicle driver or of further vehicle occupants and generates control command inputs which cause the vehicle to be transferred into a safe state. It is therefore conceivable, for example, in the case of flying objects, that the image processing unit detects on the basis of the body posture that the vehicle driver is no longer conscious, in response to which the evaluation unit generates control command inputs which causes the flying object to be transferred into a safe state, for example, by switching on a high degree of automation or the like.

In a further particularly advantageous embodiment, the control device is designed to detect the touch state of a touch-dependent control element (referred to as “hands-on detection”). For this purpose, the image processing unit is designed to detect body parts of the vehicle driver which are provided for inputting control commands at the touch-dependent control element which is provided for controlling the vehicle movement. From the detected body parts of the vehicle driver it is then possible to detect whether these body parts which are provided for control via the control element are located at the control element and whether or not the vehicle driver is therefore in contact with the control element. This can be derived, for example, from the shape of the body parts or their position in space.

This is advantageous particularly when the control elements are designed to generate opposing forces (referred to as “tactile cues”), with the result that it is necessary for the vehicle driver to be in contact with the control element. Otherwise, the “tactical cue” may move the control element, which can lead to undesired inputs of control commands.

In a further advantageous embodiment, the control signal unit is configured in such a way that contradictory control command inputs are detected and are then merged in such a way that control signals for controlling the vehicle movement can be generated.

It is therefore conceivable, for example, that the vehicle driver would like to input with his right hand a control command which contradicts the control command presented with his left hand. However, it is also conceivable that the vehicle driver indicates with his hand a control command for controlling the vehicle while with his foot he inputs an opposing or contradictory control command via a control element (for example a pedal). In these cases, suitable merging of the control signals must then be carried out so that contradictory control signals are then not applied to the controlled system.

Furthermore, the object is also achieved with a monitoring device for monitoring a touch-dependent control element for controlling a vehicle movement of a vehicle in that
a control element input interface is provided which is configured to receive manual control element control command inputs which can be input by the vehicle driver of a vehicle activating at least one touch-dependent control element,
a control command-acquisition device is provided which has
   a camera system for capturing image information relating to at least part of an operator control space of the vehicle,
   an image processing unit, which is configured to detect control element body movements of the vehicle driver and/or control element movements during the activation of the control element in order to input control element control command inputs from the captured image information, and
   an evaluation unit, which is configured to determine the manual control command inputs as a function of the detected body movements and/or control element movements, and
a monitoring unit is provided which is configured to detect a malfunction of the touch-dependent control element by comparing the control command inputs determined from the image information and the control element control command inputs received via the control element input interface.

The inventors have therefore recognized that the common inventive idea can also be used for solely monitoring the control elements of the vehicle in that the commands which are input via the control element and the control command inputs which are derived from the body movements and/or control element movements which are necessary for this are compared with one another. If a difference occurs between the commands determined by the control element and the control commands determined by means of the image information, a malfunction of the control element can be inferred.

The advantage here is that the monitoring of the control elements of the vehicle can be implemented with relatively little technology, specifically independently of the technical conditions of the vehicle. Furthermore, such a monitoring device can also be integrated subsequently into a vehicle without large retrofitting measures, wherein the control command inputs which are input via the control element can usually be tapped from a common bus system of the vehicle.

The object is also achieved according to the invention with a detection device for detecting a touch state of at least one touch-dependent control element for the controlling of a vehicle movement of a vehicle by a vehicle driver in that provision is made of
a camera system for capturing image information relating to at least part of an operator control space of the vehicle,
an image processing unit which is configured to detect body parts of the vehicle driver which are provided for inputting control commands at the touch-dependent control element of the vehicle, from the captured image information, and
an evaluation unit which is configured for detecting a touch state of the touch-dependent control element as a function of the detected body parts.

The inventors have also recognized that the inventive core can also be used alone for detecting a touch state of the control element for controlling the vehicle. For this purpose, corresponding image information is recorded using a camera, and correspondingly body parts of the vehicle driver, which are provided for controlling the vehicle via the control element, are detected using an image processing unit. As a function of the detected body parts, for example on the basis of the shape of the body parts or their position in space, it is then possible to detect whether or not the vehicle driver is in contact with the control element provided for controlling the vehicle.

This is advantageous particularly when haptic control elements which can apply an opposing force for transmitting haptic information to the control element are used in the vehicle. This is because an opposing force can be applied to the control element only when the vehicle driver is also in contact with the control element, since otherwise the vehicle driver does not notice the applied opposing force and therefore cannot perceive the information and the applied opposing force possibly undesirably results in a control command input. The application of an opposing force is therefore appropriate only when the vehicle driver is also in contact with the control element.

Furthermore, in vehicles which operate with high degrees of automation it is also necessary that corresponding “hands-on detection” can be reliably carried out. This is because if the vehicle wishes to switch over from a high degree of automation into the manual control mode owing to a serious event, it is absolutely necessary for the vehicle driver to touch the control elements provided for controlling the vehicle. Switching over or switching off of an autopilot is therefore reliably possible only when the vehicle driver also correspondingly touches the control elements. Such a touch state can also be detected safely and easily with the present invention.

The invention will be explained in more detail by way of example with reference to the appended drawings, in which:

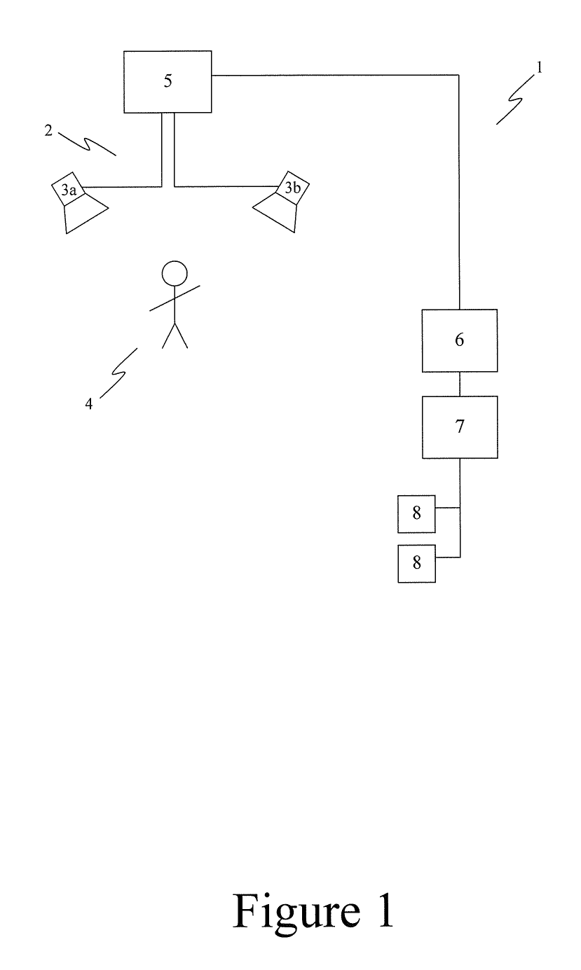

FIG. 1—is a schematic illustration of the control device according to the invention; and

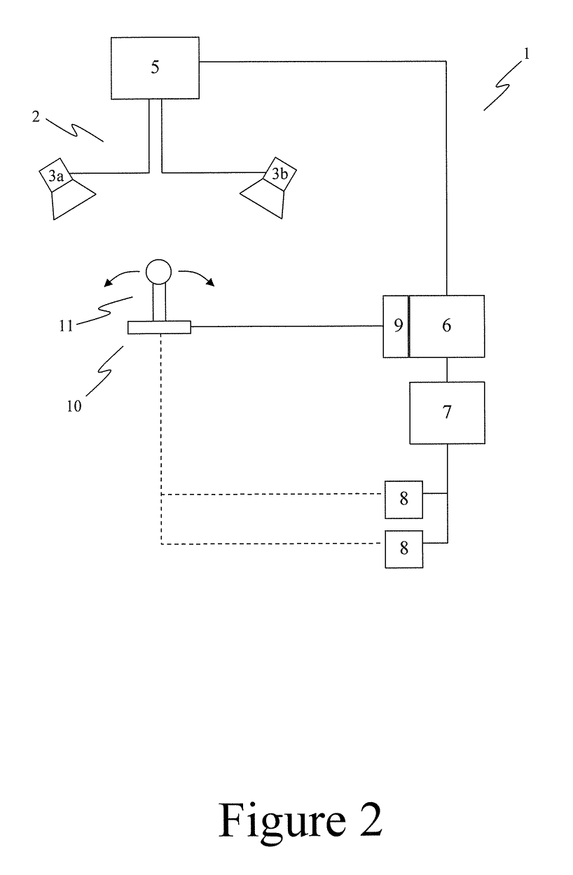

FIG. 2—is a schematic illustration of a particular embodiment.

FIG. 1 shows the control device 1 according to the invention with a camera system 2, which is composed of two cameras 3a, 3b which are arranged offset and have optical depth detection. The cameras 3a, 3b of the camera system 2 are oriented here in such a way that they capture at least part of an operator control space of the vehicle, in particular in such a way that at least the vehicle driver 4, who is intended to control the vehicle, is captured.

The cameras 3a, 3b of the camera system 2 are connected to an image processing unit 5 which receives the image information recorded by the camera system 2. The image processing unit can then detect corresponding body movements and/or body postures of the vehicle driver 4 from the captured and received image information, which can be carried out, for example, using a corresponding, real-time-capable image processing program. In this context the image processing unit 5 can abstract the information in such a way that only abstract information relating to the body movements and/or body postures of the vehicle driver 4 are then present. It is therefore possible to use the image processing unit 5 correspondingly to recognize gestures, facial expressions, movement patterns, hand signs and the like. It is also possible, for example, for the throwing up of one's hands in fright to be detected as a movement pattern, as can the body slumping down in the case of tiredness or fainting.

These body movements and/or body postures which are recognized by the image processing unit 5 are then fed to an evaluation unit 6 which derives corresponding manual control command inputs from the detected body movements and/or body postures. It is therefore possible, for example, to derive from detected body movements control command inputs such as accelerating, braking, climbing, dropping, driving to the right or driving to the left, if a corresponding body movement or movement pattern or else gesture is linked to each of these control command inputs.

If the vehicle driver 4 carries out a corresponding body movement which is stored as a control command for controlling the vehicle, this is detected by the evaluation unit 6 and passed on to the control signal unit 7, which then generates, as a function of the lack of control command inputs being detected by the evaluation unit 6, corresponding control signals for controlling the vehicle movement. These control signals which are generated by the control signal unit on the basis of the determined control command inputs are then transmitted to corresponding actuator elements 8 of the vehicle for actuation, with the result that the vehicle movement of the vehicle is correspondingly carried out. Such actuator elements 8 may be, for example, motors for controlling the steering system, the drive or the like.

FIG. 2 shows a particular embodiment of the control device 1 according to the invention. In this context, the two cameras 3a, 3b of the camera system 2 are oriented with a control element 10 which is designed to input control element control command inputs by activating the lever 11 to control the vehicle. If the lever 11 is moved, this movement of sensors is detected in the control element 10 and converted into corresponding control signals which are then used to actuate the actuator elements 8 for controlling the vehicle movement of the vehicle.

The movement of the lever 11 is captured using the camera system 2 and detected using the image processing unit 5 connected downstream, with the result that the movement or position of the lever 11 can be detected. This can, of course, also be detected on the basis of the body movement of the vehicle driver during the activation of the lever 11, since a movement of at least one body part of the vehicle driver is necessary for the activation of the lever 11. This control element movement or body movement of the vehicle driver can be detected using the image processing unit 5.

The evaluation unit 6 determines on the basis of this control element movement or body movement of the vehicle driver the corresponding control command inputs which were desired by the vehicle driver by means of the movement of the control element 10 or lever 11.

The control device 1 also has an interface 9 via which the control command inputs which are detected by the control element 10 can be fed to the evaluation unit 6 or control device 1. The evaluation unit 6 is therefore provided not only with the control command inputs which have been detected using the camera system 2 but also with the control command inputs which have been input directly at the control element by the movement of the control element 10 or of the lever 11.

By comparing these determined control command inputs with the control command control command inputs it is then possible to determine whether the control element 10 is functioning or has a malfunction. If the control element 10 has a malfunction which has been detected by the comparison, the determined control command inputs which have been determined from the image information of the camera system 2 are used for generating the control signals for actuating the actuator elements 8 by means of the signal unit 7. The control device 1 functions in this case both as a monitoring device for monitoring the functionality of the control element 10 and as a redundant secondary control in the event of failure of the control element 10.

Of course, the comparison is also carried out if no control command inputs are received via the interface 9 but the evaluation unit 6 detects a corresponding input on the basis of the movement of the control element 10. This also quite clearly makes it possible to infer a malfunction of the control element 10.

Furthermore, in this configuration it is also possible to determine on the basis of the position in space of the body parts provided for the activation of the control element 10 for controlling the vehicle whether or not the vehicle driver touches the control element or the lever 11. It is therefore also possible to determine from this a corresponding touch state of the control element by the vehicle driver.

1. Control device (1) for controlling a vehicle movement of a vehicle, having
a control command input device for inputting manual control command inputs for controlling the vehicle movement of the vehicle, and
a control signal unit (7), which is configured to generate control signals for controlling the vehicle movement of the vehicle as a function of the manual control command inputs,
characterized in that the control command input device has
a camera system (2) for capturing image information relating to at least part of an operator control space of the vehicle,
an image processing unit (5), which is configured to detect body movements and/or body postures of at least one vehicle driver (4) from the captured image information, and
an evaluation unit (6) which is configured to determine the manual control command inputs as a function of the detected body movements and/or body postures.

2. Control device (1) according to claim 1, characterized in that the camera system (2) is a 3D camera system with optical depth detection.

3. Control device (1) according to claim 1, characterized in that
the image processing unit (5) is configured to detect control element body movements of the vehicle driver (4) and/or control element movements during activation of at least one touch-dependent control element (10) from the captured image information, and
the evaluation unit (6) is configured to determine the manual control command inputs as a function of the detected control element body movements and/or control element movements.

4. Control device (1) according to claim 3, characterized in that a control element input interface (9) is provided which is configured to receive manual control element control command inputs which can be input by the vehicle driver activating the touch-dependent control element (10), and
the evaluation unit (6) is also configured to detect a malfunction of the control element (10) by comparing the control command inputs determined from the control element body movements and/or control element movements and the control element control command inputs received via the control element input interface,
wherein the control signal unit (7) is configured to generate the control signal for controlling the vehicle movement of the vehicle as a function of the detection of a malfunction.

5. Control device (1) according to claim 1, characterized in that the evaluation unit is configured to determine a critical state as a function of the detected body movements and/or body postures of the vehicle driver and to determine control command inputs as a function of the critical state, in such a way that the vehicle is transferred into a safe state.

6. Control device (1) according to claim 1, characterized in that
the image processing unit (5) is configured to detect body parts of the vehicle driver, which are provided for inputting control commands to a touch-dependent control element (10), from the captured image information, and
the evaluation unit (6) is configured to detect a touch state of the touch-dependent control element (10) as a function of the detected body parts and/or body movements.

7. Control device (1) according to claim 1, characterized in that the control signal unit (7) is configured to detect contradictory control command inputs and to merge the contradictory control command inputs, wherein the control signals are then generated as a function of the merged control command inputs.

8. Monitoring device for monitoring a touch-dependent control element (10) for controlling a vehicle movement of a vehicle, characterized in that
a control element input interface (9) is provided which is configured to receive manual control element control command inputs which can be input by the vehicle driver (4) of the vehicle activating at least one touch-dependent control element (10),
a control command-acquisition device is provided which has
a camera system (2) for capturing image information relating to at least part of an operator control space of the vehicle,
an image processing unit (5), which is configured to detect control element body movements of the vehicle driver and/or control element movements during the activation of the control element (10) in order to input control element control command inputs from the captured image information, and
an evaluation unit (6), which is configured to determine manual control command inputs as a function of detected body movements and/or control element movements, and
a monitoring unit is provided which is configured to detect a malfunction of the touch-dependent control element (10) by comparing the control command inputs determined from the image information and the control element control command inputs received via the control element input interface (9).

9. Detection device for detecting a touch state of at least one touch-dependent control element for the controlling of a vehicle movement of a vehicle by a vehicle driver, characterized in that provision is made of
a camera system for capturing image information relating to at least part of an operator control space of the vehicle,
an image processing unit which is configured to detect body parts of the vehicle driver, which are provided for inputting control command at the touch-dependent control element of the vehicle, from the captured image information, and
an evaluation unit which is configured for detecting a touch state of the touch-dependent control element as a function of the detected body parts.
